(19) United States
(12) Patent Application Publication
(10) Pub. No.: US 2016/0070464 A1
(43) Pub. Date: Mar. 10, 2016

(54) TWO-STAGE, GESTURE ENHANCED INPUT SYSTEM FOR LETTERS, NUMBERS, AND CHARACTERS

(71) Applicants: Siang Lee Hong, Canal Winchester, OH (US); Chang Liu, Athens, OH (US)

(72) Inventors: Siang Lee Hong, Canal Winchester, OH (US); Chang Liu, Athens, OH (US)

(21) Appl. No.: 14/479,383

(22) Filed: Sep. 8, 2014

(51) Int. Cl. G06F 3/0488; G06F 3/0484; G06F 3/0482

(52) U.S. Cl. CPC G06F 3/04886; G06F 3/0482; G06F 3/04842

(57) ABSTRACT

A system and method that allows convenient input of letters, numbers, and characters using an input requiring a minimal number of input buttons or keys enhanced by gestures. The system utilizes a two-stage input, first with an array “call-up” function that allows a user to select a range of letters, numbers, or characters, followed by a subsequent “specification” function that allows a user to select a specific letter, number, or character from the aforementioned array. This allows for input using wearable devices that have minimal surface area, or devices that do not require external keyboards to provide input, such as Blu-Ray players and smart televisions, while also saving space on a display, if utilized on mobile computing devices such as smartphones or tablets. The resulting input can be used in electronic communications such as email and SMS texting, or be used for word processing functions.

### BACKGROUND OF THE INVENTION

The growth in the number of mobile computing devices such as smartphones and tablets, and “wearable” computing devices in the form of glasses and watches create a demand for quick, efficient, and accurate data entry methods. Smartphones and tablets depend on a touchscreen keyboard for input. However, because of limiting factors such as the size of the display, tactile sensation of the keys and key presses that would normally be available on a conventional keyboard, virtual touchscreen keyboards are generally suboptimal. For example, a touchscreen keyboard on a smartphone or table will often consume approximately half or the display, obscuring text and other pieces of information that would be normally available on the screen. In addition, the size of the keys on the touchscreen keyboard, especially on smartphones is smaller than that of conventional keyboards, increasing the likelihood of error and slowing the input process. As far as wearables are concerned, they simply do not have sufficient surface area for a keyboard to be placed on a watch face or on the frame of a pair of glasses. Yet, it is unlikely that users will switch to a more efficient type of keyboard input if it requires a significant amount of learning.

A second source of need for a new method of keyboard input arises due to an increasing number of “smart” devices in the home, for example, televisions, refrigerators, thermostats, security systems, and Blu-Ray players. Input into these devices is highly cumbersome, often using remote control inputs where users have to push buttons to scroll across a screen, selecting individual letters and numbers. Alternatively, a touchscreen keyboard has to be used or a conventional keyboard needs to be connected to these devices whether wireless or plugged. To allow these smart devices to be fully connected as components of the “internet of things,” a convenient method input that is highly portable and made easily available.

While the aforementioned issues pertain primarily to sighted individuals, these problems are compounded in people who suffer from vision problems and blindness. Without the tactile sensation that would normally be available in conventional keyboards, users of touchscreen keyboards have to rely solely on vision to complete an input. Blind (legally and completely) individuals are unable to use this feature of touchscreen devices, and thus have limited means of data input to mobile devices and prevented from engaging with these many convenient mobile computing devices.

### BRIEF SUMMARY OF THE INVENTION

The objective of the current invention to provide a system of keyboard input for computing devices that requires a minimum number of key/button presses and virtually no need for learning. The system, method, and computer-readable medium utilize a two-stage input to reduce the need for the representation of all of the alphabets and numbers on screen (or audibly for those with vision problems). The keyboard operation module has that two stages that comprise a “call-up” function with an initial button push that calls up an array of letters, characters, or numbers, and a subsequent button push that selects a specific letter, character, or number. The reduced input requirements can be completed with action from no more than four fingers at any given point in time, allowing the task of data input to be completed with one or two hands. Button inputs are combined with gestures to expand the range of inputs and further simplify the input process. Due to the symmetric nature of the invention, left- and right-handed users are fully accommodated by a simple mirror opposite pattern of input.

Various embodiments of the current invention, including features and advantages are described in detail below. The structure and operation of the various embodiments are described in detail below, alongside reference to the accompanying drawings.

### BRIEF DESCRIPTION OF THE SEVERAL VIEWS OF THE DRAWINGS

FIG. 1 is an example table containing the key or button combinations used to “type” in letters and basic punctuation. Buttons assigned to the left hand are denoted as “L1, L2, and L3” while buttons assigned to the right hand are denoted as “R1, R2, and R3.” This pattern is preferred for right-handed individuals, but left-handed users can simply reverse the button configuration so that “R1, R2, and R3” become “L1, L2, and L3” and vice versa.

FIG. 2 is an example table containing the key or button combinations used to enter numbers and special characters. Similar compatibility for left-handed and right-handed individuals, as described in FIG. 1 also applies here.

FIG. 3 is a schematic illustration of the button setup on a tablet or smartphone device. FIG. 3A shows the configuration of six buttons needed for the system in a “portrait” orientation, i.e., where the device is upright. FIG. 3B presents the configuration of the six buttons in a “landscape” orientation, i.e., where the device is on its side.

FIG. 4 is a schematic illustrating the process of inputting data using the invention with buttons placed on the back of a smartphone. Note that the “rear view” presents a vantage point as if the smartphone itself were transparent, as if we could see straight through the back.

FIG. 4A shows the process of calling up the array of letters ‘abcdef’ on the touchscreen by pushing the L1 button or key. FIG. 4B shows the process of specifying the letter ‘b’ by pushing the R2 button, which then “types” the letter ‘b’ into the text box. Key or button presses are denoted by coloring the button in black with white text, this notation is maintained throughout the remainder of the figures within the document. This now allows a word auto-complete system to be brought up, allowing the user to select from a set of suggested words with their thumb(s).

FIG. 5 is a schematic illustrating the process of entering data using the invention when more than one button needs to be pressed, presented as a subsequent step in the typing process from FIG. 4. FIG. 5A shows the process of calling up the array of letters ‘stuvwx’ on the touchscreen by pushing the L1 and L2 buttons or keys simultaneously. FIG. 5B shows the process of specifying the letter ‘u’ by pushing the R3 button, which then “types” the letter ‘u’ into the text box. This now leads to changes in the words suggested by the auto-complete system.

FIG. 6 is a schematic illustrating the process of typing a special character, presented as a subsequent step in the typing process from FIG. 5. FIG. 6A shows the process of calling up the array of letters ‘!@#$%’ on the touchscreen by pushing the R3 button or key. FIG. 6B shows the process of specifying the letter ‘@’ by pushing the L2 button, which then “types” the character ‘@’ into the text box. Again, this leads to changes in the words suggested by the auto-complete system.

FIG. 7 illustrates the gesture-based enhancements to the input system. Three example gestures are demonstrated here that reduces the number of buttons that have to be controlled by the fingers. FIG. 7A shows a gesture to generate a backspace using the system, a counter-clockwise rotation of the device toward the left. FIG. 7B shows a clockwise rotation to the right indicating a space, akin to pressing the spacebar on a keyboard. FIG. 7C is a gesture-based method of pressing the ‘return’ or ‘enter’ key on a keyboard. The device is rotated backward and forward to indicate this action.

FIG. 8 provides two exemplar schematic illustrations of the embodiment of the invention using the touchscreen display of a mobile device for use while sending an SMS text. FIG. 8A provides an illustration of an exemplar embodiment in portrait orientation with the phone upright. FIG. 8B provides an illustration of an exemplar embodiment in landscape orientation, with the phone on its side. The screen space utilized in both orientations is minimal, and nearly a quarter of that of a conventional virtual keyboard.

FIG. 9 provides schematic exemplar illustrations of the division of a touchscreen watch face into a 7-button set in order to utilize the two-stage input system. FIG. 9A shows the configuration and division of the touchscreen on a circular watch face, while FIG. 9B shows the configuration and division of the touchscreen on a square or rectangular watch face. The “soft” or virtual segmentation of the buttons is denoted by the dashed, instead of solid lines. A button in the middle can be utilized for the space, return/enter, and backspace (Bksp) buttons.

FIG. 10 illustrates the process of utilizing the current invention using a smartwatch device. Because the watch face itself is generally expected to be fairly small in size, the texting process is displayed on another device, in this example, a smartphone, although this process would be possible with other computing devices, including desktops, laptops, smart televisions, Blu-Ray players, etc. FIG. 10A shows the call-up process similar to that of FIG. 4A, where a push of button L1 brings up the ‘abcdef’ array. In FIG. 10B, as in FIG. 4B, the letter ‘b’ is specified by a push of the R2 button.

FIG. 11 provides schematic example embodiments of the current invention by utilizing multi-touch surfaces available on smartglasses. FIG. 11A shows a two-handed version of the system, with three buttons placed on the left arm of the glasses and another three buttons on the right. FIG. 11B presents a one-handed version of the system, shown here for a right-handed user, with all of the six buttons placed on the right arm of the glasses. A left-handed user will have the six buttons on the left arm of the glasses. FIG. 11C, FIG. 11D, and FIG. 11E illustrate example swipe-gesture enhancements to the six button system. FIG. 11C shows how a forward swipe across the multi-touch surface to indicate a space, while backspace can be indicated using a backward swipe, as shown in FIG. 11D. In FIG. 11E, a front-and-back swipe of the finger is used to represent the return or enter key.

FIG. 12 provides schematic illustrations of how a user would interact with the current invention, embodied in headphones. FIG. 12A illustrates the utilization of the invention when the buttons are distributed across both earpieces. FIG. 12B illustrates how the current invention is utilized when the buttons are placed on a single earpiece. FIG. 12C illustrates how the current invention would be utilized if the buttons are placed on a controller on the headphone wires.

FIG. 13 presents examples of how physical or virtual buttons would be configured for use with headphones. FIG. 13A shows example button configurations when the buttons are evenly divided across the two earpieces. FIG. 13B shows an example button configuration with all of the buttons placed on a single earpiece. FIG. 13C provides an example button configuration on a controller placed on the headphone wire.

FIG. 14 is an example table containing an alternative set of key or button combinations used to enter letters, numbers, or characters using only 3 buttons. Instead of a “left and right” set of buttons, the two stage process is conducted as a sequence of two inputs using the same buttons.

FIG. 15 provides an example button configuration on a watch face to accommodate Braille alphabet.

FIG. 16 provides an illustration of the use of the current invention adapted to Braille for visually impaired users. Specifically, the process illustrated here is that of inputting the letter ‘m’. FIG. 16A shows the call-up phase by pressing the button corresponding to Dot 3 in Braille code. This then prompts and auditory input to the user, reading back ‘klmnopqrst’, lettering the user know that the second “block” of letters has been called-up. FIG. 16B shows that the user now has to only press the buttons corresponding to Dot 1 and Dot 4 to specify the letter ‘m’ instead of having to press three buttons simultaneously.

### DETAILED DESCRIPTION OF THE INVENTION

The detailed description refers to the accompanying drawings, which provide illustrations of exemplary and preferred embodiments of this invention. Because other embodiments are possible, especially in the wearable space (for example, using a bracelet instead of a watch), modifications can be made to the embodiments within the spirit and scope of the invention. Where possible, alternative embodiments within the spirit and scope of the invention are listed within the description. Therefore, the detailed description provided here is not meant to limit the invention. Instead, the scope of the invention is defined by the appended claims.

In a broad sense, the present invention represents a system that allows for a “shorthand” method of keyboard input. The system reduces the number of keys or buttons that are required to represent the range of alphabets, numbers, and characters used in everyday typing and communication. The invention solves the problem of existing methods of keyboard input for touchscreen-enabled mobile computing devices, which often requires that approximately 30 keys be displayed on screen. Prior art systems require that the user toggle to a different keyboard set for numbers, and another separate keyboard for special characters, and another one for emoticons. There are prior art attempts at addressing this problem. For example, U.S. Pat. No. 8,059,101 B2 presents the detection swipe gestures to invoke specific keyboard functions, such as the return, backspace, shift, caps lock, etc., while US 20130009881 A1 proposes the use of additional geometric shapes and swipe movements to select characters for input. Both of these existing approaches have drawbacks in that they require a significant level of learning in order for a user to become fully proficient in using the input system.

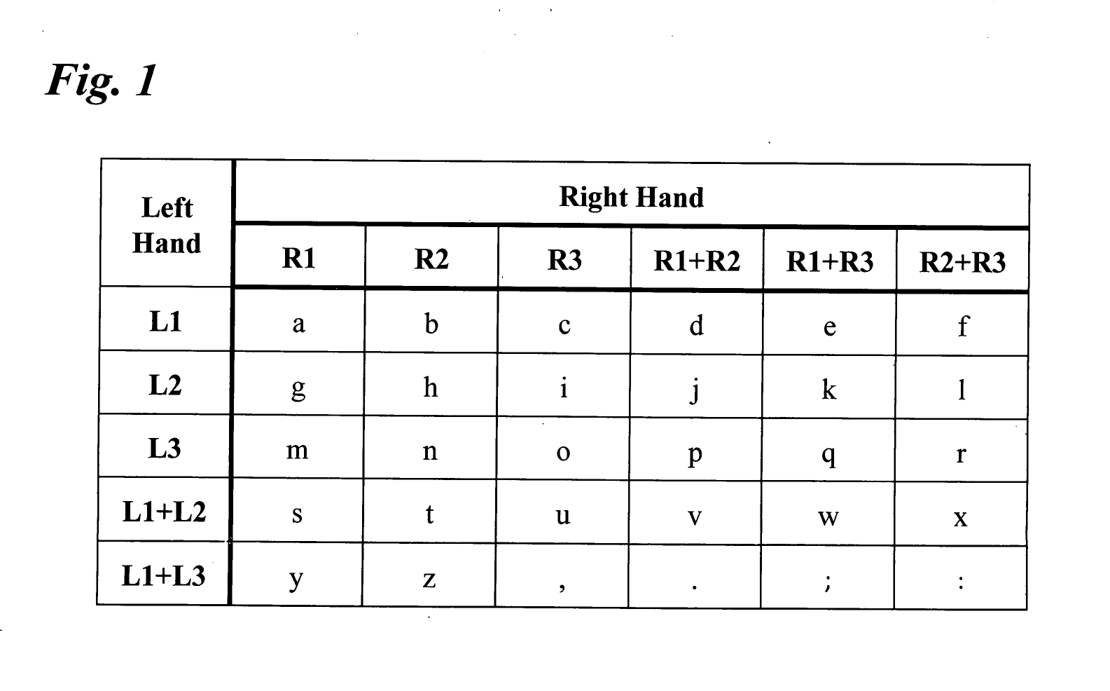

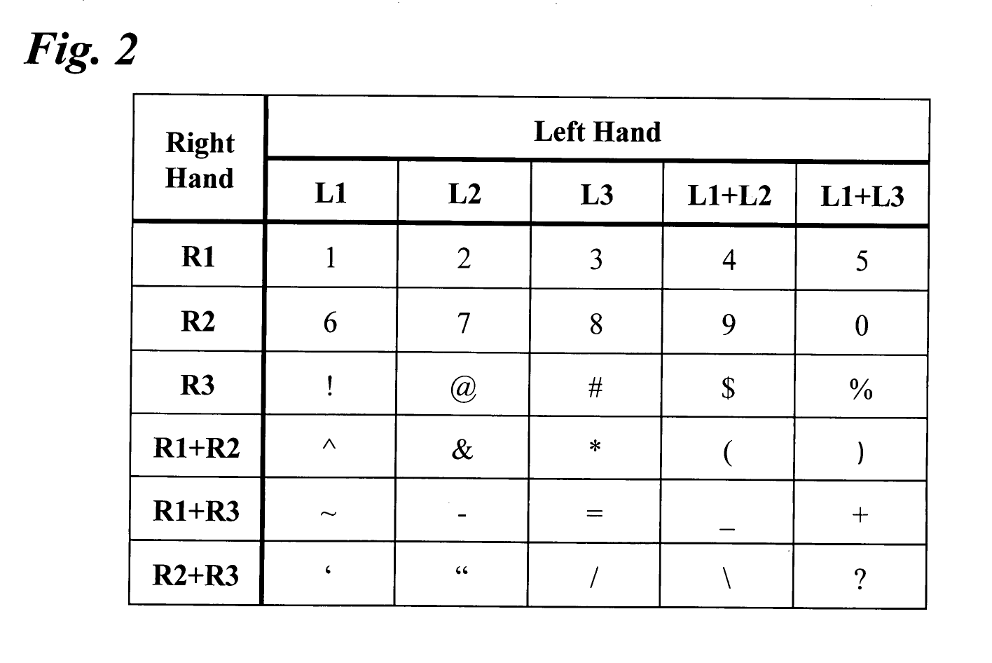

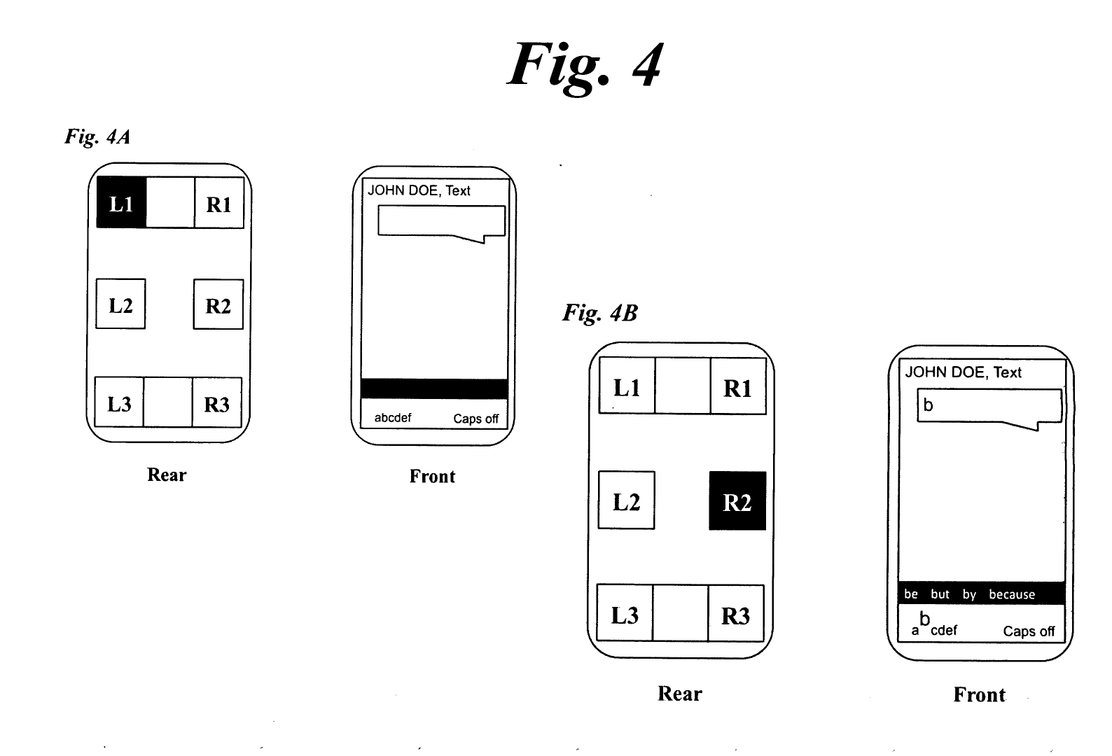

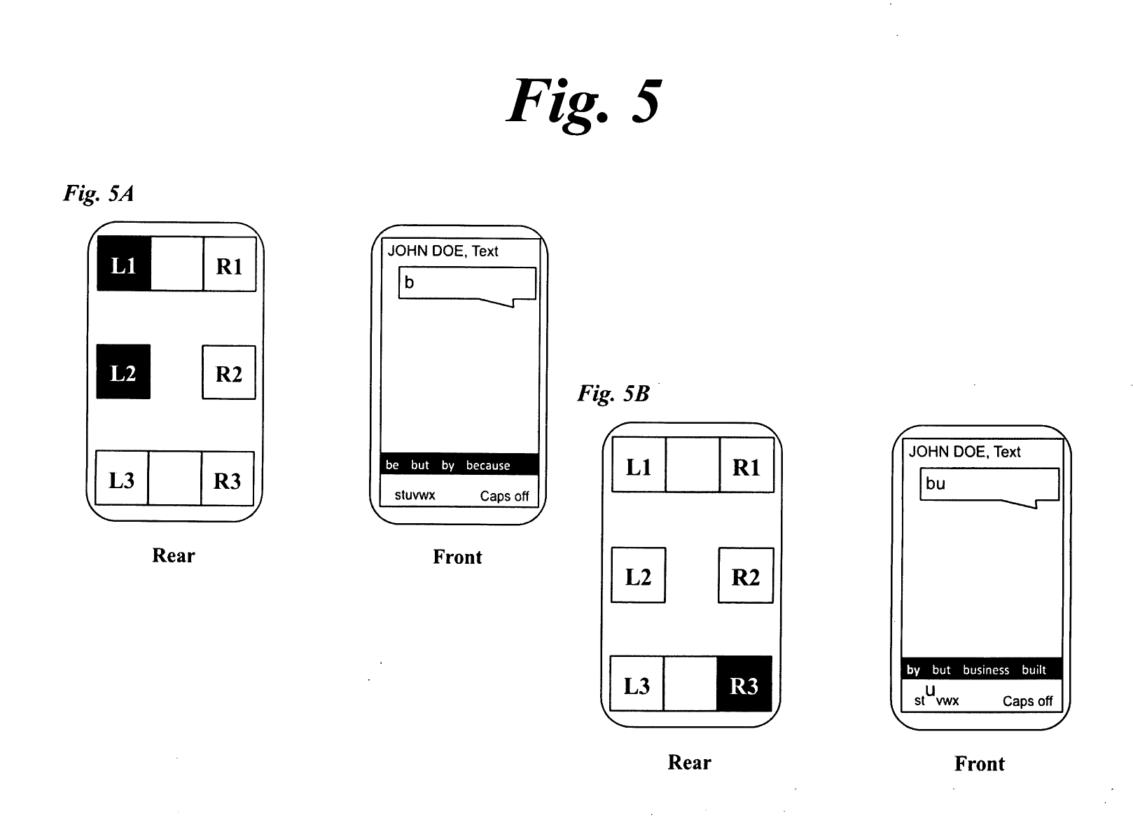

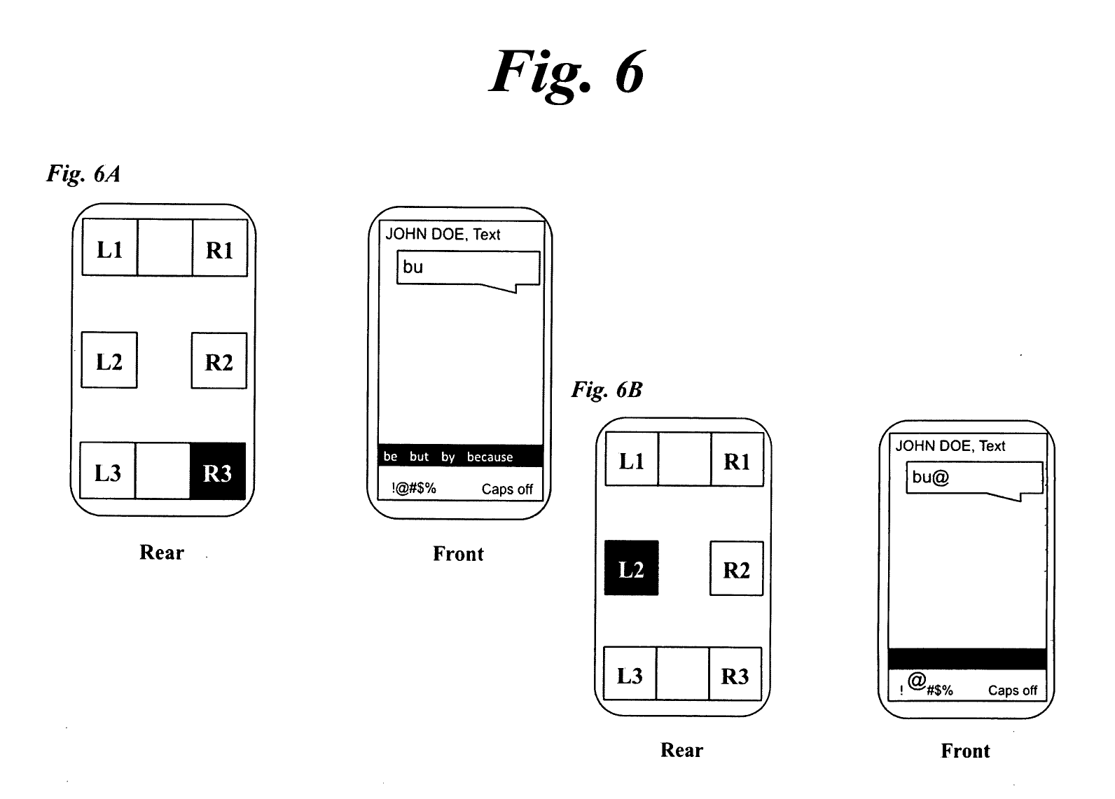

Central to this invention is the two-component input for a single letter, number, or character. As a preferred embodiment, the system comprises two sets of three keys or buttons, one set assigned to the left hand and the other set assigned to the right hand. FIG. 1 presents the table of key press combinations required to generate letters and FIG. 2 provides a similar combination table for numbers and special characters. In both FIG. 1 and FIG. 2, the leftmost column is the first button or combination of buttons to be pushed. A specific row of letters, numbers, or characters corresponds to specific button combination in the leftmost column. This allows a second input of individual button and button combinations to select a single letter, number, of character. To reduce confusion, buttons assigned to the right hand are denoted as “R1, R2, and R3” and buttons assigned to the left hand are marked as “L1, L2, and L3.” Further illustrations of the input process are provided in FIG. 4, FIG. 5, and FIG. 6, illustrated as “screenshots” during the process of sending SMS text messages.

At this point in the description, it is important to note that, for the sake of simplicity, embodiments will be described for right-handed users herein, instead of using the terms “dominant” and “non-dominant.” This is done because modifying the embodiments for left-handed users requires no more than a simple mirroring of input pattern, that is, where buttons denoted as “L1, L2, and L3” be replaced with “R1, R2, and R3” and vice versa. As an exemplar input, in reference to table in FIG. 1, calling up the letter ‘m’ would require the user to push button L3 and then button R1. Similarly, to generate the ‘+’ character, the user needs to press R1 and R3 simultaneously, and then press L1 and L3 simultaneously. The clear advantage of the system presented in the current invention is that it removes the need for separate keyboards to represent numbers, special characters, punctuation, and letters. The system of input requires action to push two buttons simultaneously at any given point in time. To increase input speed, it is likely that a user might want to prepare all of the fingers necessary for both stages of input. In such cases, at most, four fingers are needed at any moment in time. Because of the simplicity of the design, a user could feasibly complete the task of inputting keyboard data using only one hand. In essence, a user can choose to perform either or both stages of the input process can be completed with one or both hands.

The preferred button assignment pattern leaves “special” inputs unused, for example, simultaneous 3-button push on the right or left hand (i.e., R1+R2+R3 and L1+L2+L3). These unique inputs can be used to specify letter case, i.e., the caps lock, using the left hand, while the 3-button push on the right hand can be used to toggle to the use of emoticons or other images. It is preferred that the more dexterous, dominant hand control the more complicated button combinations, hence the asymmetry in the tables for the letters in FIG. 1 and the table for numbers and special characters in FIG. 2. Indeed, different numbers of buttons and finger combination patterns can be used as alternative embodiments, for example, allowing equal numbers of finger combinations for left and right hand or increasing the number of possible buttons and combinations. This would be more complicated and less convenient than the preferred embodiment, but nevertheless, should be considered to fall within the spirit and scope of the current invention. In addition, the simultaneous three-button push can be repurposed to represent other functions or toggles other than caps or emoticons. Such modifications to the preferred embodiment remain within the spirit and scope of the current invention.

Another alternative embodiment of the system is to use the same set of buttons used to call up the array of letters, numbers, or characters and to determine the specific letter, number, or character to be typed. For example, the letter ‘x’ would be called up by pushing L1 and L2 simultaneously, and then L2 and L3 simultaneously. This method is slower than using different hands to perform the call-up and specification functions, but can be functional if the user can only use one hand to input data. Naturally, the process of specifying an individual character can be set to be performed while holding down the button(s) used to call up the array of letters, numbers, or characters. This alternative embodiment should be considered to be within the spirit and scope of the invention.

One mode of use in which the system can be implemented is for mobile computing devices such as smartphones or tablets. The preferred mode of utility, instead of using the touchscreen itself, would be to provide buttons on the rear face of the device. Placing the keys/buttons on the rear of the device is practical as it does not subsume any additional space on the touchscreen. In addition, it allows the user to hold the mobile device and press the buttons, while still leaving the thumbs free to perform actions on the touchscreen itself, for example, selecting from a word auto-complete system or scrolling. These buttons can be physical or virtual, using spring loaded buttons or a multi-touch pad, for example. The latter is advantageous as it would allow users to customize the position of the buttons to accommodate hand size.

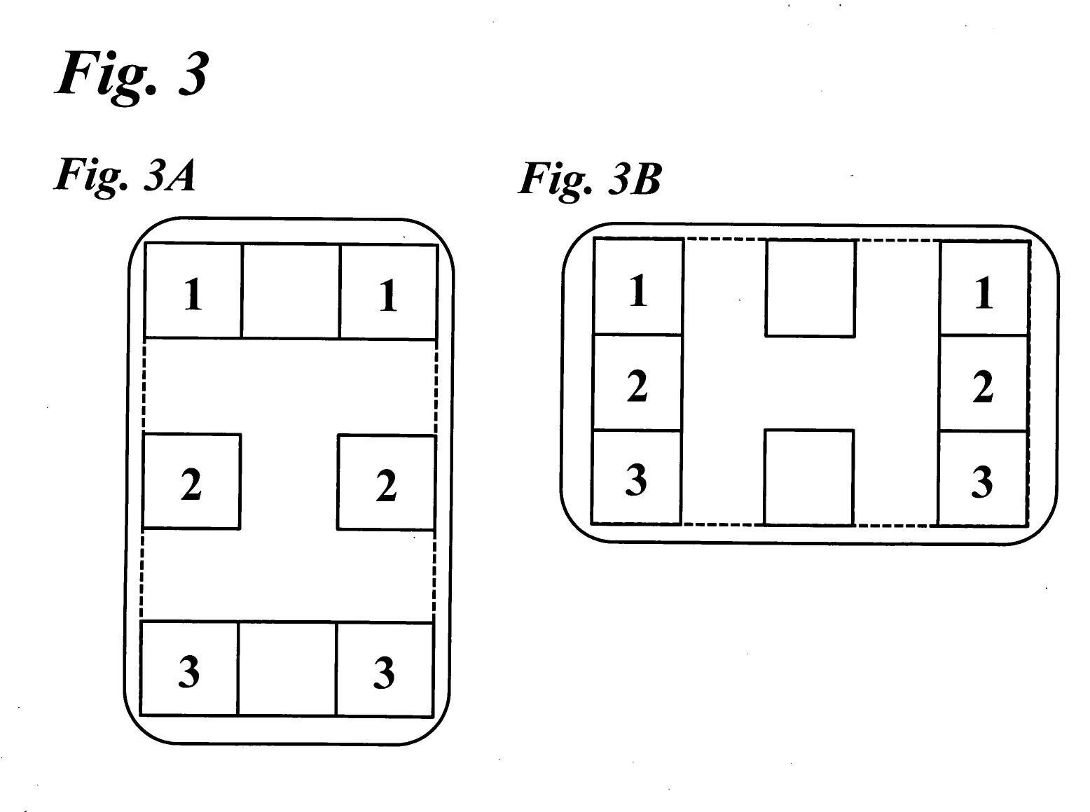

With the input at the rear of the device, a user can easily grasp the device and control the buttons or touchscreen using three fingers on each hand. As shown in FIG. 3, these buttons can be configured to accommodate both a portrait or landscape orientation of the device, as presented in FIG. 3A and FIG. 3B, respectively. FIG. 4 shows the process of using the system with a smartphone device. FIG. 4A illustrates the array call-up process, here ‘abcdef’ displayed in the bottom left corner of the display. FIG. 4B illustrates the character specification process, whereby a subsequent button press allows the selection of the letter ‘b’ that is typed into the text box. The desired letter in the bottom left corner is displayed as being larger than the others within the array. Similarly, FIG. 5A and FIG. 5B provide illustrations of the call-up and specification processes, respectively, for situations where the call-up requires two buttons to be pressed simultaneously. FIG. 6A and FIG. 6B illustrate a situation where a user would like to input a number or special character. FIG. 6A shows the selection of the ‘!@#$%’ array, with the specification of the ‘@’ represented in FIG. 6B. It is important to note that these illustrations are not designed to limit the configuration and placement of the various aspects of the system on the device display, and is simply to serve as an example. Different display modes and patterns should be considered to fall within the spirit and scope of this invention.

Beyond saving space on the front of the screen, the use of only 3 buttons for each hand leaves both thumbs free to hold the mobile device in place and manipulate the touchscreen display. This way, the user still has the capacity to utilize other functions of the smartphone or tablet. As shown in FIG. 4, FIG. 5, and FIG. 6, the word autocomplete function can still be utilized with the thumbs when an appropriate word suggestion is provided. The user can then tap the desired word using either thumb.

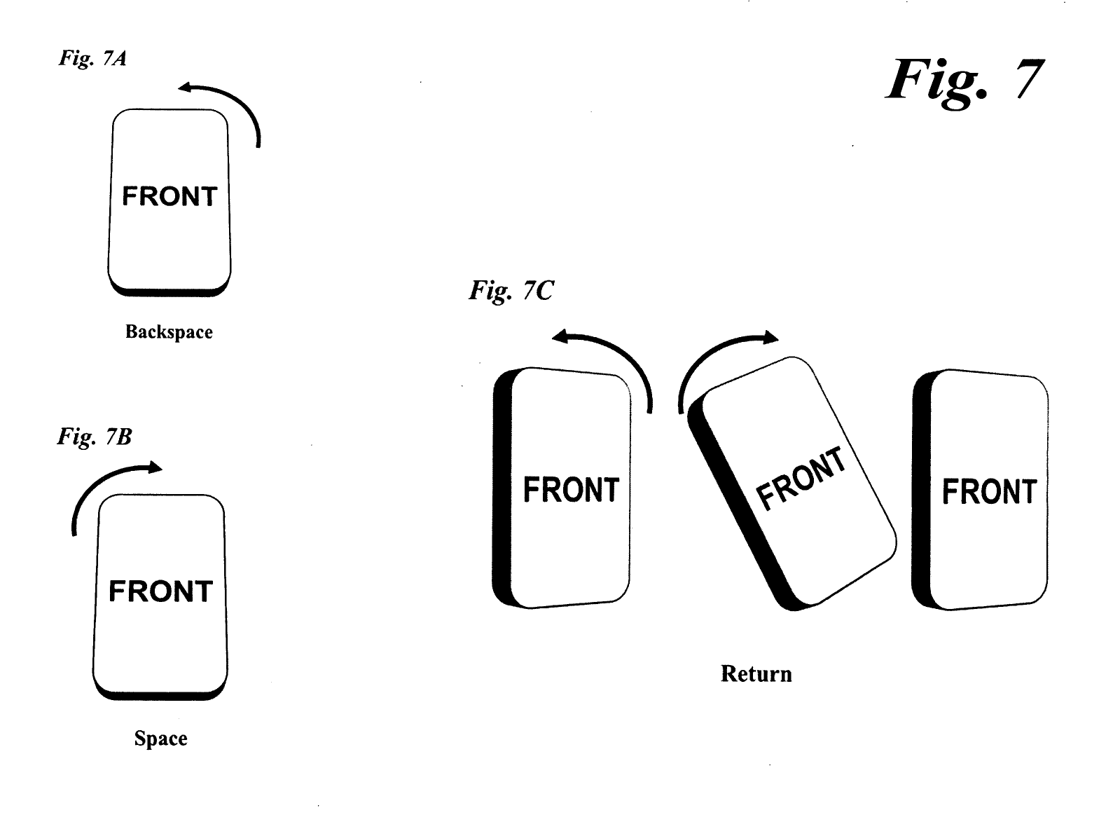

This mode of input can be enhanced by gestures, further saving on buttons that have to be pushed. FIG. 7 examples of such gestures. FIG. 7A shows how one might perform a movement to “press” the backspace button, by tilting the smartphone or tablet toward the left, generating a small counterclockwise rotation that can be detected by motion sensors within the device. FIG. 7B shows how a rightward tilt, generating a clockwise rotation of the device can be used to denote a space. FIG. 7C shows how a backward and forward tilting of the device can be used to denote a push of the return or enter key. This is particularly advantageous as it reduces the need for additional buttons and button combinations to replace these keys that are normally available on a convention ‘QWERTY’ keyboard. Indeed, a variety of other gestures can be included to denote a plurality of other keys, and thus, should be considered to fall within the spirit and scope of the current invention.

In addition, if virtual buttons on a touchscreen are utilized instead of physical buttons, swipe gestures are an alternative to the movement of the device. For example, swiping to the left between the space between the virtual buttons can be used to denote a backspace; swiping from left to right between the space between the virtual buttons can be used to denote a space, and a downward swipe of the finger indicating a return or press of the enter key.

It is important to note that the number of buttons and number and types of gesture-based enhancements of the system are mutable, as increasing the number of gestures reduces the need for buttons and vice versa. For example, one might choose to reduce the number of gestures by increasing the number of buttons, or one could choose to combine swipe and movement gestures to indicate certain emoticons and could be used in lieu of buttons or button combinations. As a result, while the tables presented in FIG. 1 and FIG. 2 represent a preferred embodiment of the current invention, it can be adapted and adjusted to accommodate a higher or lower number of gesture-based inputs and/or buttons. Therefore, other combination tables and button/key assignments in conjunction with gesture inputs should be considered to fall within the spirit and scope of the current invention.

As a preferred embodiment, an ideal case would be one where the buttons or additional touchscreen on the rear of the device are built directly into the smartphone or tablet itself and be standing components of the device. However, to accommodate existing devices, an alternative embodiment is to construct cases or holders for the smartphone or table that include these buttons or additional touchscreen. The case will be able to communicate with the smartphone or tablet via a variety and plurality of modes, all of which should be considered to be within the spirit and scope of the current invention. For example, wireless methods such as, but not limited to, near field communication (NFC), Bluetooth, WiFi, or radio frequencies are potential methods of communication. Wired communication between the case and device can also be utilized, for example, but not limited to using a universal serial bus (USB) connection or transmitting information through the headphone jack.

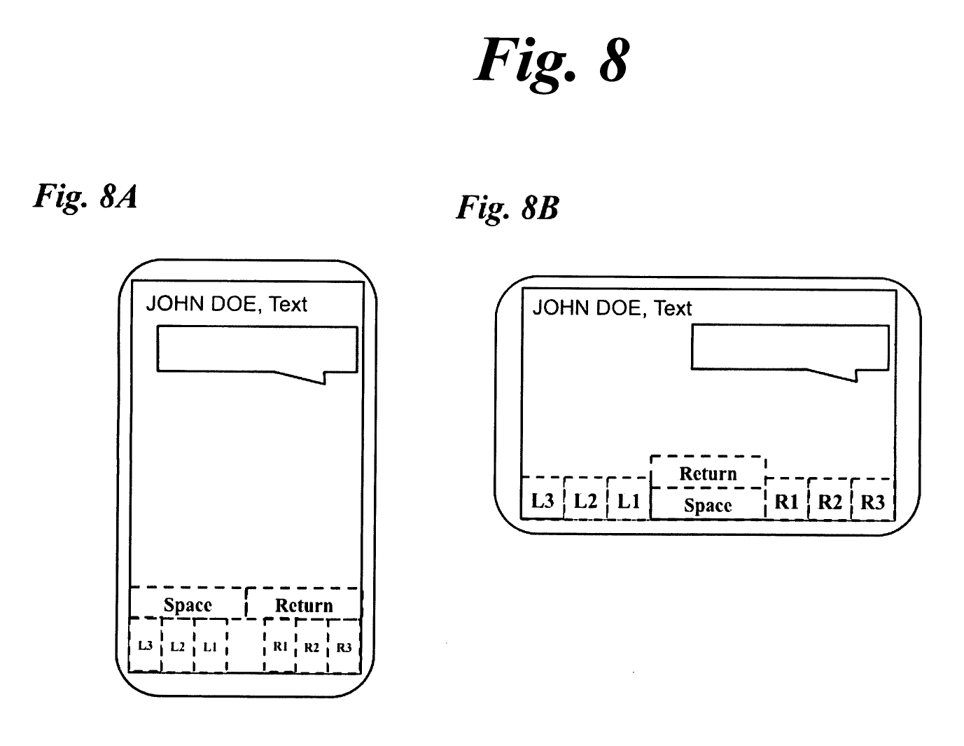

Although not necessarily the preferred mode in terms of saving display space, the most straightforward method of utilizing the input system would be to utilize a devices' touchscreen itself. As shown in FIG. 8, instead of placing the buttons on the rear of the device, part of the touchscreen can be utilized to provide a user with the necessary 6-buttons to generate input. FIG. 8A and FIG. 8B provide illustrations of the system deployed in portrait and landscape orientations, respectively. From FIG. 8, it can be seen that the system will still take up a portion of the screen albeit much less screen space that a virtual keyboard is required for this utility. Highly practiced individuals, i.e., users who have memorized the table pattern and the spatial locations on the touchscreen, could opt to do away with the visual cues of: A) the number, letter, or character array being called-up by the first button(s) pressed; and B) the defined locations of each of the six buttons, i.e., “invisible” buttons. At the minimum, this embodiment has the advantage of the rear buttons in that no further hardware is required over existing products currently available on the market. It is important to note that the positions of the buttons on the screen in FIG. 8A and FIG. 8B are meant to serve as examples and other button configurations should still be considered to be within the spirit and scope of this invention.

Utilization of the current invention with a smartphone or tablet does not limit the input process to the device itself. The smartphone or table might also be used to generate input on other computing devices, for example, a smart refrigerator, smart television, Blu-Ray player, desktop, or laptop computer. In these cases, both wireless and wired methods of communication are viable. For example, wireless methods such as, but not limited to, near field communication (NFC), Bluetooth, WiFi, or radio frequencies are potential methods of communication, can be used to transmit the information from the smartphone or tablet to one or more computing devices. Wired communication between the smartphone or tablet and other computing device(s) can also be utilized, for example, but not limited to using a universal serial bus (USB) connection or transmitting information through a headphone jack.

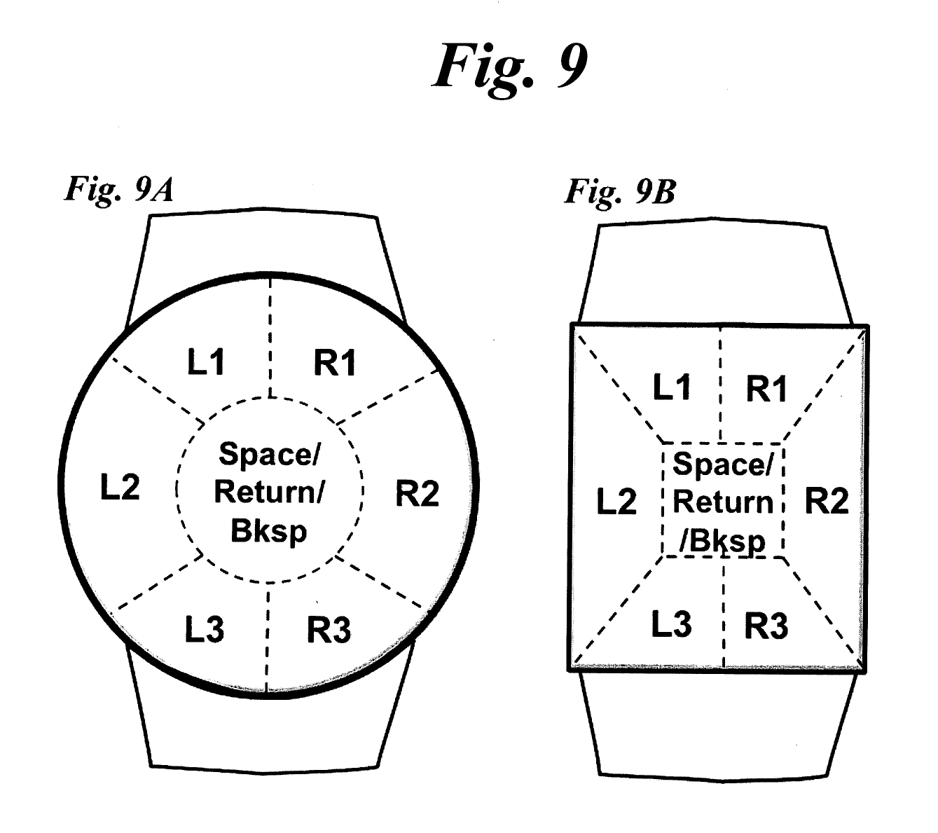

The system of input in this current invention is especially functional for wearable computing devices, which inherently possess limited space to house buttons. Wearable computing devices are being designed to be both ubiquitous and pervasive, that is, to be “always-on” and worn constantly for convenient use. Yet, because it is virtually impossible for an entire keyboard to be placed on any of these devices, they are unable to provide convenient means of input, as either a standalone device, or to another device. In FIG. 9, two example methods of dividing the touchscreen of a smartwatch to accommodate the six-button configuration are illustrated. FIG. 9A shows the division of a circle or round watch face into 6 buttons, while FIG. 9B illustrates the division of a square or rectangular watch face into the 6 buttons needed to utilize the system. Notice that the center of the touchscreen is reserved for space (single tap) and enter (double tap), and backspace (hold button). Unlike the smartphone or tablet, rotating the device means that the user might lose the placement of their fingers on the buttons in a manner that would slow down the input process. Instead, swiping movement gestures can be used to enhance or even replace the button in the center, and should be considered to fall within the spirit and scope of the invention. Also, physical buttons instead of virtual buttons on a touchscreen can be used for the input process, a topic that will be addressed later in the document with regards to utility of this invention for individuals with vision impairments.

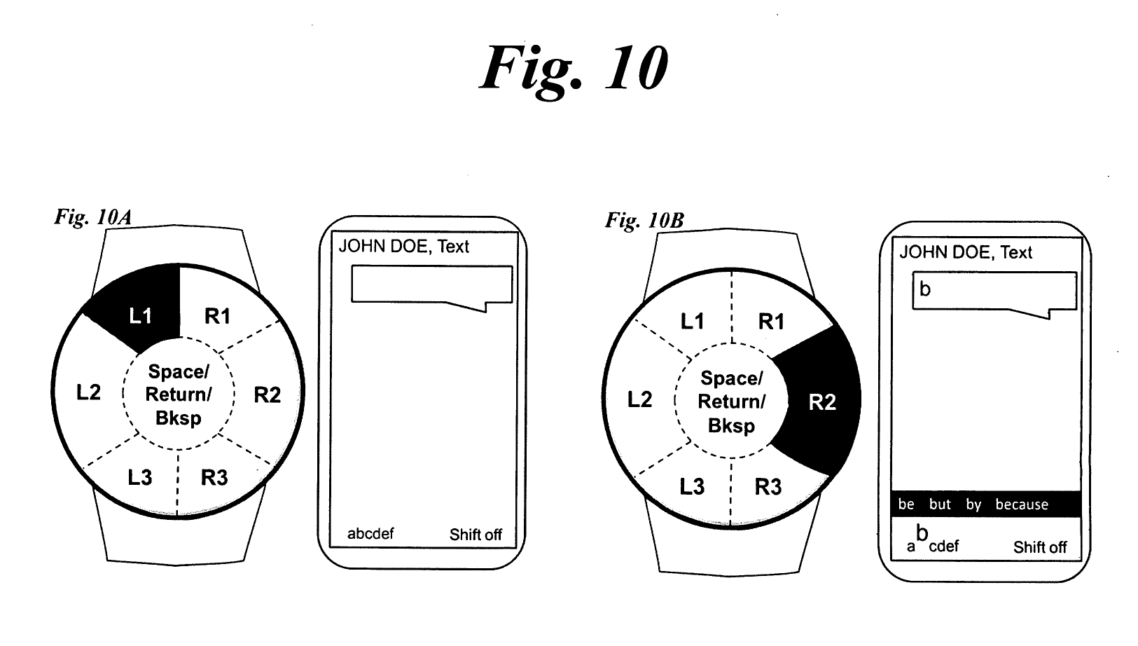

The convenience of utilizing the input system described in the current invention using a smartwatch is illustrated in FIG. 10. At most, a maximum of only two fingers (three for special cases) are needed at any given point in time, the current invention ideal as a means of using a smartwatch as an input device because the entire process can be performed using a single hand. An initial tap of the L1 button brings up the initial array on the display of another device, as illustrated in FIG. 10A. The ‘abcdef’ array can be displayed on any computing device, for example, but not limited to, a desktop computer, laptop computer, smartphone, tablet, smart television, and so on. Once the array is called up, the user now pushes on the R2 button in order to specify the letter ‘b’ as input. Depending on the size of the watch face, the input process could be displayed directly on the smartwatch touchscreen, and should also be considered to be within the spirit and scope of the current invention.

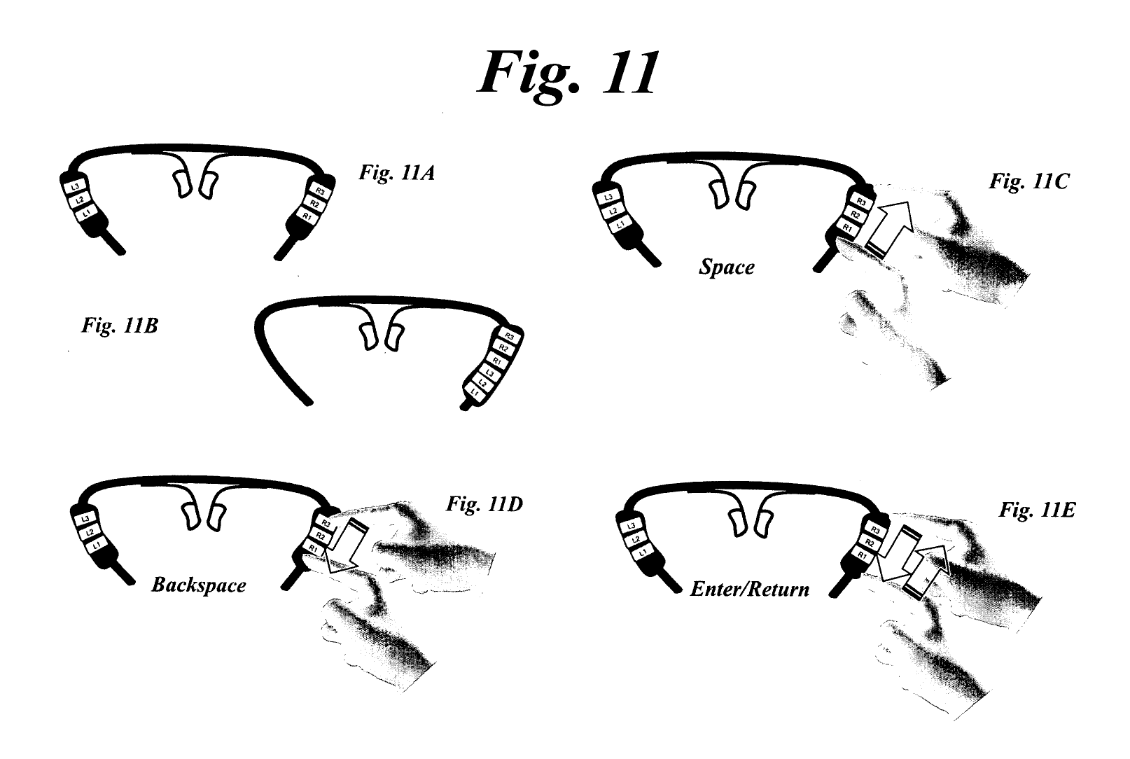

Another mode in which the current invention can be utilized would be in the form of “smart” glasses. Because smartglasses are equipped with multitouch surfaces on the arms of the glasses, virtual buttons can be generated on the arm in order to allow smartglasses to utilize the system of input presented in the current invention. As shown in the examples provided in FIG. 11, the six buttons needed for the input can be dispersed across both arms of the glasses, as shown in FIG. 11A, or placed completely on one arm, as shown in FIG. 11B (note a left-handed user would prefer placement on the left arm of the glasses). Here, a multi-touch surface with virtual buttons is preferred to physical buttons as a pushing action would not be ideal, especially since it is against the head. Swiping gestures are ideal for utilization of the current invention for smartglasses, using the examples shown in FIG. 11C, FIG. 11D, and FIG. 11E. In FIG. 11C, the process of inputting a space is conducting with a forward swipe of the finger. A rearward swipe of the finger on the multi-touch sensor indicates a backspace, as shown in FIG. 11D. A back-and-forth swiping motion would indicate a push of the ‘enter’ or ‘return’ key on a keyboard, as shown in FIG. 11E. These preferred modes should serve as best-practice examples, but not limited to these specific gestures. Other swiping gestures or even head movement gestures (e.g., head moves left for backspace, head move to the right for space, and a downward nod for enter) that can be used to enhance and augment the six keys to represent other shortcuts on a keyboard should be considered to fall within the scope and spirit of the current invention.

A display for the glasses itself is preferred, as it would allow the call-up array to be displayed, but is not essential. If a display is available and placed in from of the eye(s), the input process can be completed using the smartglasses as a standalone device, without the need for another computing device to complete the task of typing and sending a message. Otherwise, the smartglasses can be used instead as a mode of transmitting an input to another computing device, a similar process to the one described for the smartwatch utilization of the current invention.

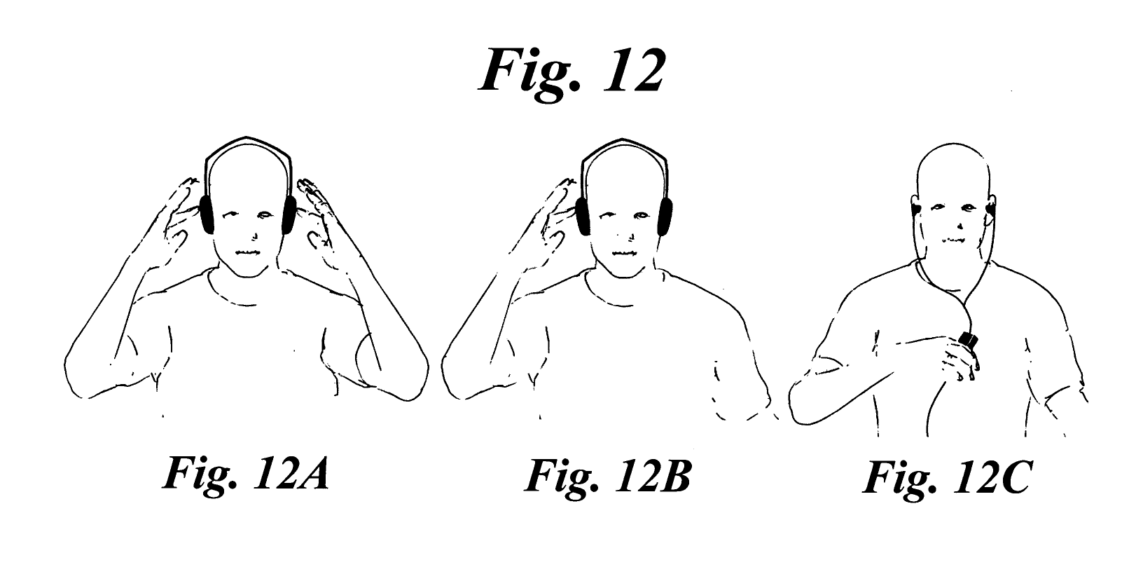

Another form of wearable device that would be able to utilize the current invention can be embodied in headphones. A similar principle to that of the smartglasses can be applied, where the physical or virtual buttons can be placed on the earpieces, with either all of the buttons divided evenly between the two earpieces, or all six buttons placed on one headphone. The process of using the current invention with buttons divided across both earpieces is shown in FIG. 12A, while the process of using the current invention with all of the buttons placed on a single earpiece is shown in FIG. 12B. One additional possibility is that wired headphones with small earpieces could have a controller added onto the wire, shown in FIG. 12C.

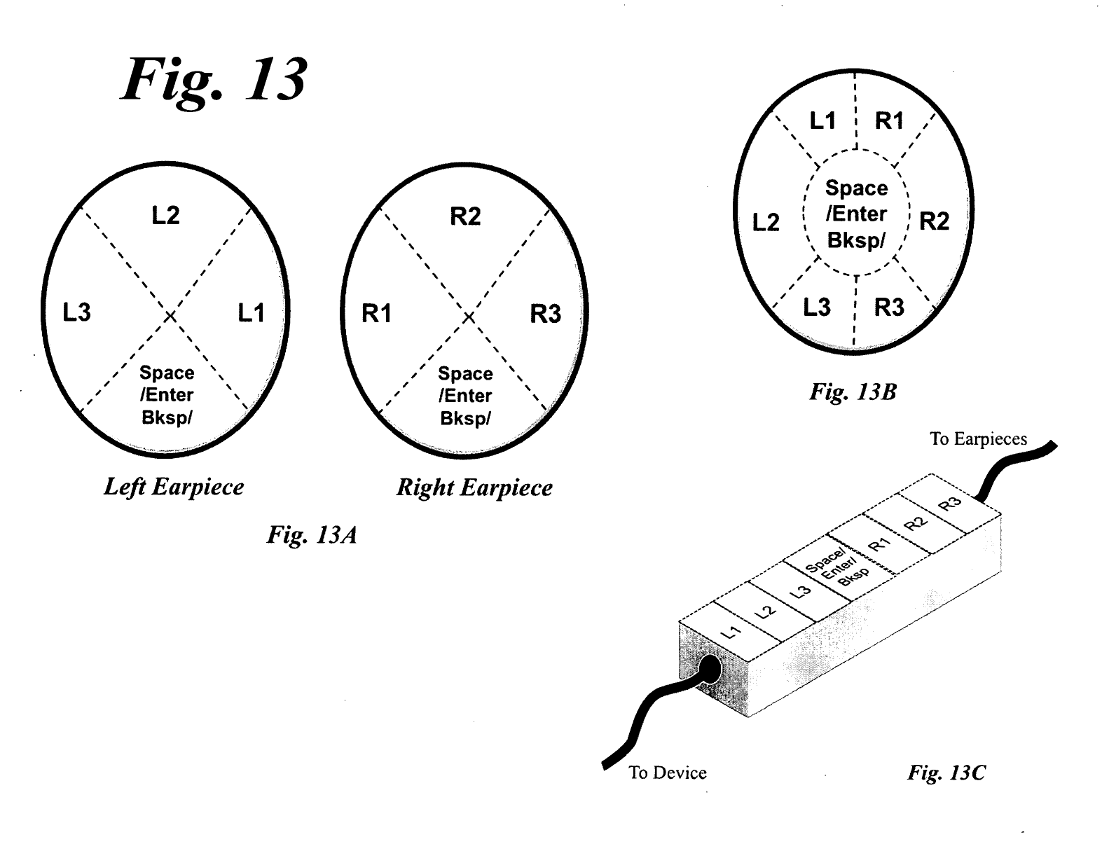

Example configurations of the virtual or physical buttons to be used with the headphones are provided in FIG. 13. In FIG. 13A, the buttons are divided across the two earpieces, with three buttons on the left (L1, L2, and L3) and three buttons on the right (R1, R2, and R3). An extra button on both earpieces can be reserved for space (single tap), enter (double tap), and backspace (hold button), or they can each serve different functions (for example, backspace on left, space on right), both are viable alternatives. For the case where all of the buttons are placed on a single earpiece (left or right depending on the user's handedness), the configuration of buttons is similar to that of the circular watch face, shown in FIG. 13B. In FIG. 13C, an exemplar button configuration for a wired controller for the headphones is shown. Using this design, a user can choose to perform the data entry process using either one or both hands. If the current invention is used with headphones, instead of displaying the visual cue of the letter, number, or character array that has been called-up, this can be transmitted as auditory information to the headphones. As with smartglasses, if the headphones are equipped with a motion sensor such as an accelerometer with a gyroscope, the system of input can be enhanced by head movement gestures similar to those used with smartglasses. It is important to note that the embodiment of the current invention need not be restricted to wearable computing devices. Rather, a set of physical of virtual buttons can be simply mounted or added to existing glasses, necklaces, bracelets, watches, etc. that do not possess any computing capacity. As long as information can be relayed to a computing device, the system of input described in the current invention can be utilized, and thus, such embodiments should be considered to fall within the spirit and scope of the current invention.

Another potential embodiment of the current invention is in household computing devices or appliances, for example, but not exclusive to, desktop and laptop computers, smart televisions, refrigerators, dishwashers, washers and dryers, and Blu-Ray players. Many of the aforementioned devices utilize a remote control that often serves as the primary (sometimes only) method of entering text into the device. Other devices might have no means by which text can be entered. The purpose of the text is needed when a user might want to search for a particular movie, or utilize social media, or surf the web, or leaving notes for other users using the aforementioned smart devices. However, the conventional method of entering text using a remote control is often restricted to five buttons, comprising four direction buttons (i.e., up, down, left, and right) and a button for selection. To input text or numbers, a user will have to direct a cursor using the aforementioned buttons and select letters or numbers individually, often having to make numerous key presses to move the cursor over a desired letter, or number. The two-stage method presented in the current invention can be utilized to greatly reduce the time taken to perform these inputs and increase the convenience of the process, by simply adding one or two more buttons to the existing configuration. This space-saving design allows a small keypad to be placed on the device or appliance. For embodiments in a motion-sensing remote control, swiping or movement gestures can be added to enhance the input process, for example, to represent special characters or the backspace, space, and enter.

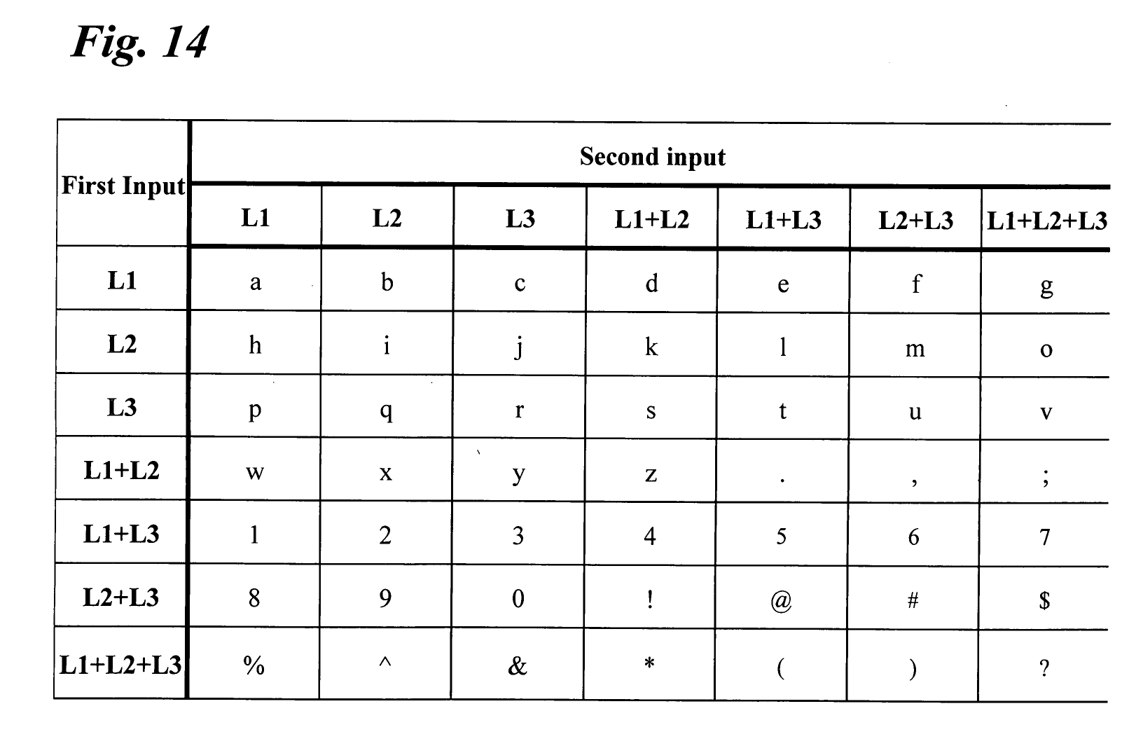

To maximize space saving, a three button system would also prove to be functional, albeit, preventing data entry using two hands. In this case, only three buttons, B1, B2, and B3, would be needed, and the input would be entered in sequence. A different lookup table, presented in FIG. 14 is needed for this case. In FIG. 14, the first input is used for the call up stage, specifying the letter, number, or character array. The second input is then used to specify a specific letter, number, or character. Although it is not necessarily the preferred mode of input in terms of speed as it prevents the use of two hands to complete the input process, nevertheless, it is more convenient in terms of space and the number of buttons required for input. Similar gesture enhancements as mentioned previously can be used for space, backspace, and return.

A segment of the population who currently have the most difficulty in using virtual keyboards on touchscreen mobile devices to input data to computing devices are individuals who suffer from visual impairments, specifically, the legally and completely blind. Without tactile sensation that comes from the use of a conventional, spring keyboard, the keys being pressed would be more difficult to discern by a completely blind user. In addition, for those blind individuals who choose to use a physical conventional keyboard for input, the benefits of portability of smartphone and tablet mobile devices is lost, as the user would then be forced to bring a keyboard with them wherever they go.

For visually impaired individuals, instead of displaying the call-up array, the letter, number, or character range can be provided as auditory information, i.e., read to the user. This is advantageous as not all blind individuals have been trained to use and memorize the Braille “code.” Especially useful for blind individuals are the embodiments of the current invention in wearable form, that is, glasses, headphones, or watches. All that a blind user would need to be provided with a raised “bumps” on the touch surfaces to indicate the position of the buttons. With the watch and headphone systems in particular, physical buttons can be implemented instead of multi-touch surfaces to provide increased tactile feedback. The design provided on the multi-touchscreen presented earlier in FIG. 9A and FIG. 9B can simply be replaced with physical buttons that have raised surfaces that allow a blind user to distinguish one button from another.

Because the invention comprises a six button system it is immediately capable of accommodating Braille code, which comprises a six dot system of representing alphabets and numbers as raised surfaces insofar that they can be read by the blind using tactile information. Braille keyboards also comprise six button inputs. However, one of the disadvantages of entering Braille code on wearable devices is that 21 of the 26 letters of the alphabet require at least three buttons to be pressed simultaneously, with nine letters requiring four buttons, and two letters requiring five buttons to be depressed simultaneously. While usable, having the regularly press various patterns of four or five buttons simultaneously would test the limits of dexterity and accuracy of the fingers of many users.

The two stage input system presented in the current invention is a more ideal method of entering Braille alphabet in a manner that reduces dexterity demands and the number of buttons that have to be pressed at any given point in time. An important aspect of the Braille alphabet system is that it divides the alphabet into three distinct configurations. The first set of letters, ‘a’ through ‘j’ utilize only the “upper cell” or dots 1, 2, 4, and 5. The second set of letters, ‘k’ through ‘t’ are replicates of the same upper cell, with only dot 3 added to the original patterns. For example, the letter ‘a’ is represented only by dot 1, while ‘k’ is represented by dots 1+3, ‘c’ is represented by dots 1+4, while ‘m’ is represented by dots 1+3+4. The third set of letters, ‘u’ through ‘z’ with the exception of ‘w’ add dot 6 to the previous set. For example, ‘k’ is represented by dots 1+3 while ‘u’ is represented by dots 1+3+6. The letter ‘o’ uses dots 1+3+5 while the letter ‘z’ uses dots 1+3+5+6. The letter ‘w’ is unique as it was not part of the French language when the Braille alphabet was invented, and is represented by dots 2+4+5+6.

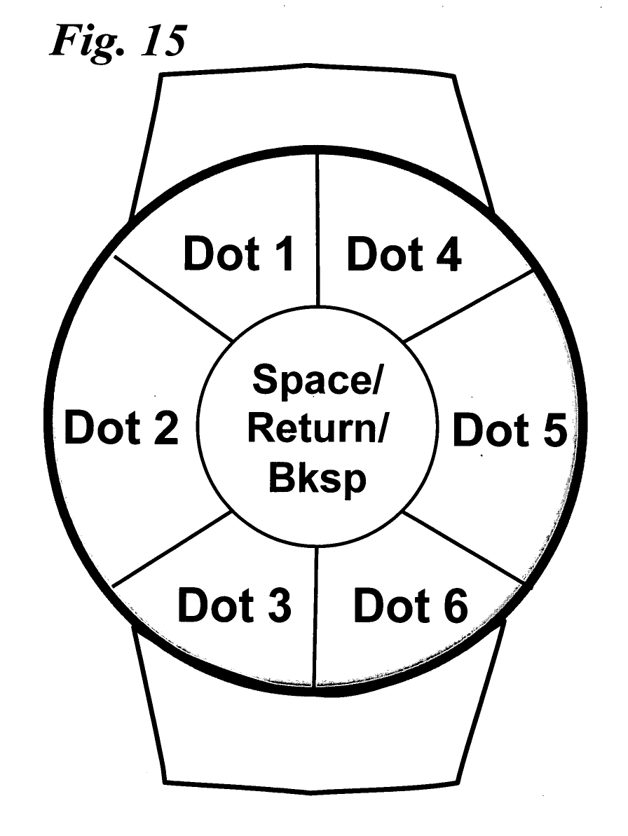

As a an example, the watch faces shown in FIG. 9 can then be converted to accommodate Braille alphabet by replacing the R and L buttons with the physical spatial configuration of the six Braille dots as they would be represented on paper. This exemplar spatial configuration, shown in FIG. 15 is advantageous because reading Braille requires that the reader sense the spatial orientation of the raised dots using tactile information from their fingertips. By mirroring the spatial configuration of the dots on the input device, it allows a skilled Braille reader to directly translate their memorized map of dot positions for a given letter to that of the buttons that need to be pressed.

A modified two stage input is preferred to simply pressing buttons corresponding to the dots of the Braille alphabet in order to reduce the number of fingers that need to be involved in the entry process. Because dot 3 and dot 6 are not used for alphabets ‘a’ through ‘j’, at most four fingers is the maximum number that will need to be used at any given point in time for only one single case, the letter ‘g’ requiring dots 1+2+4+5 to be pressed. For the second set of alphabets, ‘k’ through ‘j’, the user will first press the button corresponding to dot 3 and then proceed to press the appropriate buttons corresponding to the “upper cell,” dots 1, 2, 4, and 5. For these alphabets in the second set, the only letter that would require four fingers for input would the letter ‘q’, which normally requires dots 1+2+3+4+5, but, dot 3 has already been represented by the initial button push. For the remaining set of characters, the user can press buttons 3+6, prior to entering the dot patterns for the letters ‘u’, ‘v’, ‘x’, ‘y’ and ‘z’. The letter ‘w’ is actually the dot pattern for the letter ‘j’, that is dots 2+4+5, with the addition of dot 6. This means that the user can first press dot 6 and then proceed to enter the pattern for the letter ‘j’. An alternative shortcut would simply be for the user to press dot 6 as a method of entering the letter ‘w’. Using the embodiment of the current invention for Braille code, a blind user need only remember and enter the dot configurations for the letters ‘a’ through ‘j’.

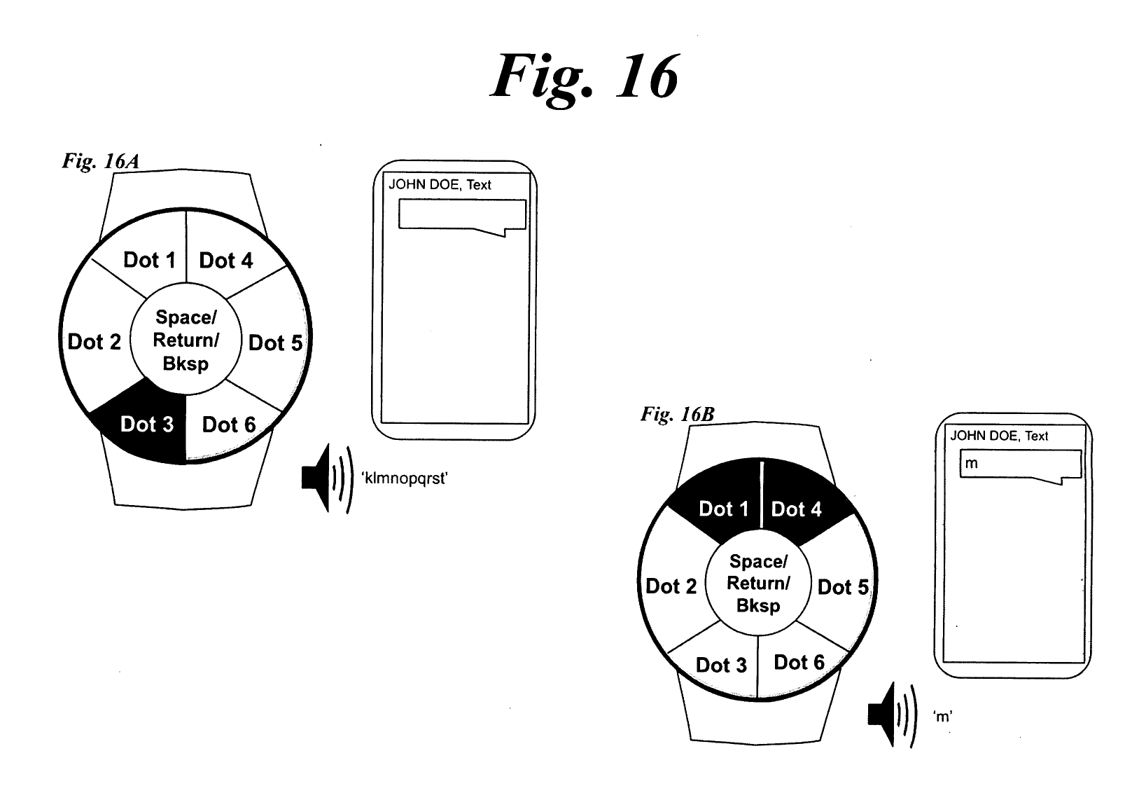

The process of entering data using the two stage system modified for Braille is presented in FIG. 16. Here, a situation where an alphabet from the second set of letters ‘k’ through ‘t’ is being entered, specifically, the letter ‘m’. Instead of having to press all three buttons simultaneously, the user first presses the button corresponding to dot 3, as shown in FIG. 16A. This then provides the user with an auditory cue that the second set of letters has been called up. The user then has to only provide the remaining dots for the letter ‘m’, dot 1 and dot 4 (this is in fact the dot pattern for the letter ‘c’), as shown in FIG. 16B. From FIG. 16, one can see how the two-stage input process simplifies the positions that need to be achieved by the fingers, increasing the convenience of the input process.

In standard Braille, numbers are often represented as doubles of the letters ‘a’ through ‘j’, representing 1, 2, 3, 4, 5, 6, 7, 8, 9, and zero. For example, the number one is represented by ‘aa’, two is represented by ‘bb’, and so on. Alternatively, a hash ‘#’ symbol is placed first to denote numbers, for example, ‘#a#’ is the number one, ‘#ab#’ is twelve. This is a relatively inconvenient method of entering numbers. Here, a gesture enhancement can included by adding a movement of the wrist, for example, moving the hand away from the body, which would be detected by the sensors in the smartwatch, to indicate that numbers are to be entered. Once the hand is moved back toward the body, the system returns to typing letters.

Indeed, there are other “coded” forms that can be used with the two stage approach, for example, Morse code. In fact, users might even choose to replicate the general ‘QWERTY’ reconfiguration using the two stage approach, or an initiated user might choose to even invent their own code pattern. Nevertheless, various codes that employ the two stage system of input, i.e., the call-up and specification procedures, and in other cases, with added gesture-based enhancements, should be considered to remain within the spirit and scope of the current invention.

It is important to note that a wearable device can communicate the input using the current invention to a computing device via any number of different modes or a plurality of modes, all of which should be considered to be within the spirit and scope of the current invention. Similar to the example of the smartphone case, wireless methods such as, but not limited to, near field communication (NFC), Bluetooth, WiFi, or radio frequencies are all viable methods of communication, can be used to transmit the information from the wearable device to one or more computing devices. Wired communication between the wearable device and other devices can also be utilized, for example, but not limited to using a universal serial bus (USB) connection or transmitting information through the headphone jack.

The numerous advantages of the current invention over the prior art. First, its use requires minimal manual dexterity and coordination, demanding control from only two fingers at any given point in time. In fact, for individuals who are extremely slow typists, this mode of input reduces the space needed to be covered by the hands and fingers, and minimizes the need for manual dexterity and precise hand-eye coordination. Using the current invention, slow typists will be able to increase the speed at which they are able to enter data into a computing device over that of using a conventional ‘QWERTY’ keyboard. Second, the system reduces a standard ‘QWERTY’ keyboard to only six buttons, allowing the system to be deployed on wearable devices such as watches or glasses, situations where space is at a premium, and there is no possibility of housing an actual keyboard. An added benefit arises because virtually all languages across the globe utilize the ‘QWERTY’ keyboard configuration (including character-based languages such as Chinese), allowing the system to be utilized globally. Third, its intuitive design and use of alphabetical order virtually requires no further learning. In addition, because the call-up process provides the user with the array of letters, numbers, or characters to select from, no memorization is required, although, repeated use will likely allow users to be able to input data at high speeds. Fourth, the system is ideal for accommodating users with visual impairments by simply providing physical buttons with tactile cues to denote the various buttons. Because a 6-button key set is used, it is directly compatible with Braille code. At the same time, the current invention also overcomes the need for the learning of Braille code, a skill or knowledge base that is known to a very small proportion of blind individuals. Fifth, is a discrete method of input that is appropriate for PINs or passwords being typed by a user, as it makes visually recognizing a letter, number, or character sequence more difficult, e.g., snooping or an “over-the-shoulder” hacking attempt, especially in situations where the call-up array and specified letter, number, or character are hidden, and the buttons are made invisible.

1. The invention claimed is a two-stage, gesture enhanced system and method of entering letters, characters, or numbers into a computing device as an alternative to a virtual keyboard that can be utilized across all written languages that utilize a keyboard input, comprising:
“button or key assignment table(s)” that assign letters, numbers, or characters to combinations of button presses, wherein:
the roles of individual buttons and/or a plurality of buttons is defined, and used as a method of controlling the two input stages, and determining the final selection of the letter, number, character.
a “call-up” stage, where a user presses a single button or plurality of buttons to initiate the data entry or input process, wherein:
a set or array of letters, numbers, or characters is “called-up” when a button or plurality of buttons is pushed; and
the set or array of letters, numbers, or characters is assigned to the button or plurality of buttons by the assignment table; and
the set or array letters, numbers, or characters assigned to the button or plurality of buttons is represented to the user as visual (presented on a display) or auditory (read back to the user) information.
a “specification” stage, where the user selects or specifies a single letter, number, or character from the set or array provided in the call-up stage, wherein:
pressing of a button or plurality of buttons determines a specific letter, number or character as output; and
a specific letter, number or character is assigned to the button or plurality of buttons provided in the assignment table; and
the specific letter, number or character assigned to the button or plurality of buttons is represented to the user as visual (presented on a display) or auditory (read back to the user) information; and
the specific letter, number or character assigned to the button or plurality of buttons is entered as an output and communicated to a computing device.
gesture enhancements to the input process, wherein:
a single movement or actions or plurality of movements or actions of a user are captured and utilized as modes of input in conjunction with, or in addition to, the two stages of input, that is, the call up and specification stages; and
specific input roles are assigned to the gesture(s) that can be used to enhance or replace the pressing of a single button or plurality of buttons; and
the specific output assigned to the gesture(s) is entered as an output and communicated to a computing device.
an option to complete either or both of the two stages of the input process using either one or both hands.

2. The embodiment of claim 1 in mobile computing devices such as smartphones or tablets that increases convenience and reduces the space taken up by a conventional virtual keyboard, comprising:
a minimal number of physical or virtual keys or buttons on the rear of the device, either as part of the mobile computing device itself or added on to the device in the form of a case or holder; alternatively
virtual buttons or keys can be presented for use on the device's touchscreen itself; and
supplemented by single gestures or a plurality of gestures, such as swiping gestures on the touchscreen or movement gestures where the device is moved; and
the gesture or plurality of gestures are used as a mode of input, specifying a specific entry from a keyboard, and communicated to the mobile computing device(s).

3. The embodiment of claim 1 as a “wearable” method of input on items regularly worn on the body, such as glasses, watches, headphones, bracelets, or necklaces, comprising:
a minimal number of physical or virtual keys or buttons that are either mounted on or added to the wearable item; and
a mode of communication from the physical or virtual keys or buttons to a computing device; and
supplemented by single gestures or a plurality of gestures, such as swiping gestures on a multi-touch sensitive surface or movement gestures where the item itself is moved; and
the gesture or plurality of gestures are used as a mode of input, specifying a specific entry from a keyboard, and communicated to computing device(s).

4. The embodiment of claim 1 in household devices and appliances such as desktop computers, laptops, and other smart devices, such as smart televisions, refrigerators, and Blu-Ray players comprising:
a minimal number of physical or virtual keys or buttons that are mounted on the device or appliance itself; or
as an external device that communicates with the household computing device or appliance, for example, a remote control or mini-keypad; and
supplemented by single gestures or a plurality of gestures, such as swiping gestures or movement gestures in situations where an external input device such as a mini-keypad or remote control is used, where the motion of the external input device itself is detected; and
the gesture or plurality of gestures are used as a mode of input is used to specify a specific entry from a keyboard, and communicated to the household computing device(s).

5. The adaptation of the system in claim 1 for use as a simplified method Braille input, comprising:
a modified “call-up” stage, where a user presses a single button or plurality of buttons to initiate the data entry or input process; and
specifies the alphabet set that is about to be entered, that is, ‘a’ through ‘j’, or ‘k’ through ‘t’, or ‘u’ through ‘z’; and
the alphabet set is presented to the user in the form of auditory (read back to the user) information; and
a modified “specification” stage, where a user enters the corresponding Braille dot combination corresponding to the first alphabet set of ‘a’ through ‘j’, meaning that for any given alphabet entry, at most, four fingers have to be involved; and
the specific letter, number or character assigned to the button or plurality of buttons is communicated to the user as auditory information and entered as an output communicated to a computing device; and
enhanced by gestures, whereby a single movement or actions or plurality of movements or actions of a user are captured and utilized as modes of input in conjunction with, or in addition to, the two stages of input, that is, the call up and specification stages; and
specific input roles are assigned to the gesture(s) that can be used to enhance or replace the pressing of a single button or plurality of buttons; and
the specific output assigned to the gesture(s) is entered as an output and communicated to a computing device.
